(19) United States
(12) Patent Application Publication
(10) Pub. No.: US 2024/0351683 A1
(43) Pub. Date: Oct. 24, 2024

(54) VERTICAL TAKE-OFF AND LANDING FLYING CAR

(71) Applicant: Yong Sik SHIN, Busan (KR)

(72) Inventor: Yong Sik SHIN, Busan (KR)

(21) Appl. No.: 18/685,552

(22) PCT Filed: Aug. 18, 2022
(86) PCT No.: PCT/KR2022/012320

§ 371 Date: Feb. 22, 2024

(30) Foreign Application Priority Data
Aug. 25, 2021 (KR) 10-2021-0113048

(51) Int. Cl. B64C 29/00; B60F 5/02; B64C 37/00; B64D 27/34

(52) U.S. Cl. CPC B64C 29/0033; B64C 37/00; B64D 27/34; B60F 5/02

(57) ABSTRACT

A vertical take-off and landing flying car includes: power systems for both ground-traveling and flying in which, at upper portions of intermediate portions of central lines of wheel shafts of front wheels and rear wheels of a four-wheel electric car, motors are installed to be adjacent, parallel, and symmetrical to each other at left and right sides with respect to a central line of a chassis.

### TECHNICAL FIELD

The present invention relates to a power and driving transmission system configuration structure of a vertical take-off and landing (VTOL) flying car that can selectively travel on the ground or fly with a single chassis.

### Background Art

Numerous attempts have been made since the past to mass produce and supply flying cars that can selectively travel on the ground or fly with a single chassis, but the flying cars are not being actively mass-produced and supplied due to reasons such as lack of practicality due to all of them requiring a runway.

In recent years, with development and performance improvement of parts related to electric cars and electric airplanes, that is, various types of high-output high-performance motors and batteries, continuous significant technology development of drones, unmanned aircrafts, and the like, and the need to additionally secure transportation means to address traffic congestion or the like in big cities, companies such as Bell, Airbus, Boeing, Uber, and Tesla have introduced the “flying car” concept, and some of the companies have developed prototypes and are preparing to actually supply flying cars, but most of the flying cars are vertical take-off and landing (VTOL) flight vehicles that are unable to travel on roads.

Also, even in the case of a small number of VTOL flying cars such as personal air and land vehicles (PAL-Vs) that can travel on roads, most of them, including short take-off and landing (STOL) flying cars or short take-off and vertical landing (STOVL) flying cars, need a minimum runway, and full VTOL flying cars which account for very few of them inevitably have insufficient thrust performance and flight function or have low usability as cars. Also, a form in which separate flying power and driving devices are provided to be attachable to and detachable from a ground-traveling vehicle is inconvenient and lacks practicality and safety. As a result, none of the above are actually being actively developed.

Meanwhile, among technical terms relating to the related art of the present invention, the terms “power train” and “drive train” are currently being interchangeably used to refer to the same concept. In the present invention, in order to more appropriately and clearly describe the technical spirit and configuration of the present invention, among relevant major parts, power-related major parts such as a motor, a clutch, and a transmission which are related to a typical power train will be collectively referred to as a power system, and parts other than the power system that belong to driving transmission devices such as a driving transmission shaft, ground-traveling wheels, and a flying rotor are related to a drive train and will be collectively referred to as a driving system. The driving system will be classified into a ground-traveling driving system and a flying driving system. Although the entire body including the power system, the driving system, and other parts may be referred to as “airframe” when used for flying and referred to as “chassis” when used for ground-traveling, since the main purpose of use would be ground-traveling, the entire body will be referred to as “chassis” in all cases for convenience.

### DISCLOSURE

### Technical Problem

In order to overcome the problems described in the background art and secure practicality as a flying car, securing a vertical take-off and landing (VTOL) structure for a take-off method is most crucial, and in addition, it is essential to appropriately secure efficient structures and arrangement of power and driving devices suitable for both ground-traveling and flying, weight distribution having balance and symmetry, an output-to-weight ratio of a flight vehicle relating to key used power and the type, size, performance, and the like of a flying rotor, a load of a disk rotary plate of a rotor blade, and generated thrust, and it is also necessary to implement a flying car in the form of a typical vehicle in order to secure safety, ease of maintenance and repair, usability, and the like.

### Technical Solution

The present invention provides a vertical take-off and landing (VTOL) flying car which can both travel on the ground and fly, the flying car having a structure of a four-wheel electric car using an electric motor as a power source, wherein one driving motor is installed for each wheel, the driving motors are, different from conventional cases, installed at left and right sides of an upper portion of a central portion of a shaft of each wheel or left and right sides directly behind front and rear bumpers of a chassis that are spaced a predetermined distance from the shafts of the wheels, the driving motors are installed so that a central line of each motor is perpendicular or parallel to the shaft of one wheel according to the type of structure of the flying car, sets of a clutch and a transmission that meet conditions and structural requirements for ground-traveling and flying are coupled to both front and rear ends of each motor, the ground-traveling set is coupled in the case of an inner side of the chassis, the flying set is coupled in the case of an outer side of the chassis, an independent power system for both ground-traveling and flying, which has a transmission, a clutch, a motor, another clutch, and another transmission coaxially, linearly, and integrally formed in that order, is installed for each wheel of the four-wheel electric car such that a total of four identical power systems are installed in the chassis, and a structure that allows a single identical motor of each power system to be selectively used for ground-traveling or flying is secured.

Although driving force transmission devices such as ground-traveling wheels and a flying rotor, that is, a ground-traveling driving system and a flying driving system, are inevitably formed separately from the power systems, the power systems and the driving systems all have a reasonable, efficient structure and are able to be provided together without interfering with each other in the structure and form of a chassis of a typical car. In particular, the flying driving system has a VTOL structure that does not require a runway, is configured to appropriately secure a load of a disk of a blade, and is able to be opened and closed to be embedded in an inner space at front and rear portions of the chassis, thus implementing the form of a typical car that does not have a flying device separately attached to an outer portion thereof.

The present invention presents flying car structures equipped with several different types of combinations of the power systems and the driving systems for specifically securing the VTOL flying car having the above-described structure in a four-wheel electric car. Since the amount of content is quite large, in order to avoid overlapping content and verbose description, details of each flying car structure will be described in the embodiments below and the claims, and in this section, a summary of the flying car structures will be given.

First, in a flying car structure, driving motors each having a central line perpendicular to a shaft of one wheel are installed at an upper portion of the shaft of one wheel, and at left and right sides with respect to a central line of a chassis, a total of four identical power systems for both ground-traveling and flying, which are disposed parallel to each other and each of which has a transmission, a clutch, a motor, another clutch, and another transmission coaxially, linearly, and integrally configured in that order as described above, a ground-traveling driving system connected to the transmissions of each power system at an inner side of the chassis, and a vertically standing rotor configured to be stored in front and rear portions of the chassis during ground-traveling and then stand at left and right side surfaces of the front and rear portions of the chassis, receive a driving force from the transmissions of each power system at an outer side of the chassis, and be driven during flying are provided. This flying car structure is content related to claim 1.

Second, in a flying car structure, power systems for both ground-traveling and flying and a ground-traveling driving system in a chassis have the same structure as in the first flying car structure, and a horizontally rotating/deploying type coaxial contra-rotating double rotor configured to be stored in front and rear portions of the chassis during ground-traveling and then horizontally deploy at left and right sides of the front and rear portions of the chassis, receive a driving force from flying transmissions of each power system at an outer side of the chassis, and be driven during flying is provided. This flying car structure is content related to claim 2.

Third, in a flying car structure, power systems for both ground-traveling and flying and a ground-traveling driving system in a chassis have the same structure as in the first flying car structure, and a vertical threefold ducted-fan type rotor which is a flying driving system and includes a bottom-layer flying driving part which is a coaxial contra-rotating vertical double ducted-fan type rotor configured to be stored in the bottom of an inner space of front and rear portions of the chassis during ground-traveling and then, while fixed to the chassis, receive a driving force from the transmissions of each power system at an outer side of the chassis and be driven during flying, a middle-layer flying driving part which is a thin ducted-fan type rotor configured to be stored in the middle of the inner space of the front and rear portions of the chassis during ground-traveling and then deploy integrally with the front and rear portions of the chassis and be driven by its own motor during flying, and a top-layer flying driving part which is a thin ducted-fan type rotor configured to be stored in the top of the inner space of the front and rear portions of the chassis during ground-traveling and then horizontally deploy at each of left and right side surfaces of the front and rear portions of the chassis and be driven by its own motor during flying is provided. This flying car structure is content related to claim 3.

Fourth, in a flying car structure, different from the first flying car structure, driving motors each have a central line parallel to a shaft of one wheel, and at left and right sides directly behind front and rear bumpers of a chassis that are spaced a predetermined distance from the shafts of the wheels, a total of four identical power systems for both ground-traveling and flying, each of which has a transmission, a clutch, a motor, another clutch, and another transmission coaxially, linearly, and integrally installed in that order as described above, a ground-traveling driving system connected to the transmissions of each power system at an inner side of the chassis, and a horizontally rotating/deploying type single rotor which is a flying driving system and configured to be stored in the chassis during ground-traveling and then deploy at left and right sides of front and rear portions of the chassis, receive a driving force from the transmissions of each power system at an outer side of the chassis, and be driven during flying are provided. This flying car structure is content related to claim 4.

### Advantageous Effects

In a vertical take-off and landing (VTOL) flying car according to the present invention, different from the arrangement of motors in a typical electric car, power systems each including a motor are arranged so that a central line of each power system is perpendicular to a shaft of one wheel or parallel to the shaft of one wheel while spaced a predetermined distance therefrom. Through such a structure, a flying rotor can be configured to be efficiently stored without causing any problem in a chassis. By ground-traveling or flying clutches configured to be engaged or disengaged and transmissions configured to be connected that are integrally coupled at both ends of the motor of each power system to fit certain conditions and characteristics according to the inner side or outer side of the chassis, power can be switched and used for either ground-traveling or flying using a single motor. In this way, costs can be significantly reduced due to not requiring a separate high-output motor and an inverter (or controller), which prevents a significant increase in the price of the flying car, and it is possible to secure effects such as suppressing an increase in the weight of the chassis and simplifying the chassis, and making the parts and the weights thereof symmetrical in the front-rear and left-right directions.

Also, since a flying driving system is embedded in an inner space at front and rear portions of the chassis, the form of a typical car that does not have a flying device added to an outer portion thereof can be secured. In this way, due to implementing the form of a typical ground-traveling car, it is possible to secure usability, ease of maintenance, and the like, and simultaneously, there is a great advantage in that user inconvenience due to transition between ground-traveling and flying can be eliminated. Also, since a four-rotor flight system having a very common structure identical to a quadrotor drone is secured, the weight of the chassis is reasonably distributed, and the center of gravity is secured about the center of the four rotors, each rotor can be separately driven and easily controlled to implement various flights. In this way, it is possible to provide the chassis which does not require higher education and a high level of license for operating, facilitates application of automatic autonomous flying, and can be optimally applied even to transportation service. As an electric car, each of the four wheels can be independently driven by separate control of each motor, and due to mounting a known high-output motor required for VTOL flight, ultra-high performance similar to performance of hypercars can be provided in ground-traveling.

### DESCRIPTION OF DRAWINGS

FIG. 1A shows perspective views of an upper portion (a) and a lower portion (b) inside a chassis relating to a configuration of each power system and driving system of a flying car including a vertically standing rotor according to claim 1 of the present invention.

FIG. 1B is a top view of the inside of the chassis relating to the configuration of each power system and driving system of the flying car including the vertically standing rotor according to claim 1 of the present invention.

FIG. 1C shows perspective views of portions of the standing rotor of the flying car including the vertically standing rotor according to claim 1 of the present invention.

FIG. 1D shows perspective views of an interior and an exterior of the chassis in a state in which the rotor of the flying car including the vertically standing rotor according to claim 1 of the present invention is standing.

FIG. 2A shows a lateral view (a) and a rear view (b) of a configuration of each power system and driving system of a flying car including a horizontally rotating/deploying type coaxial contra-rotating double rotor according to claim 2 of the present invention.

FIG. 2B is a plan view relating to the configuration of each power system and driving system of the flying car including the horizontally rotating/deploying type coaxial contra-rotating double rotor according to claim 2 of the present invention.

FIG. 3A shows a lateral view (a) and a rear view (b) of a configuration of each power system and driving system of a flying car including a vertical threefold ducted-fan type rotor according to claim 3 of the present invention.

FIG. 3B is a plan view relating to the configuration of each power system and driving system of the flying car including the vertical threefold ducted-fan type rotor according to claim 3 of the present invention.

FIG. 4A shows a lateral view (a) and a rear view (b) of a configuration of each power system and driving system of a flying car including a horizontally rotating/deploying type single rotor according to claim 4 of the present invention.

FIG. 4B is a plan view relating to the configuration of each power system and driving system of the flying car including the horizontally rotating/deploying type single rotor according to claim 4 of the present invention.

### MODES OF THE INVENTION

Hereinafter, embodiments of a vertical take-off and landing (VTOL) flying car according to the present invention that relate to configurations, functions, operations, and the like of the invention according to each claim will be described in detail with reference to the accompanying drawings. Detailed description of configurations or known functions and operations of structures of universal, general, or additional parts irrelevant to the key, essential gist of the present invention will be omitted.

First, a structure relating to claim 1 will be described.

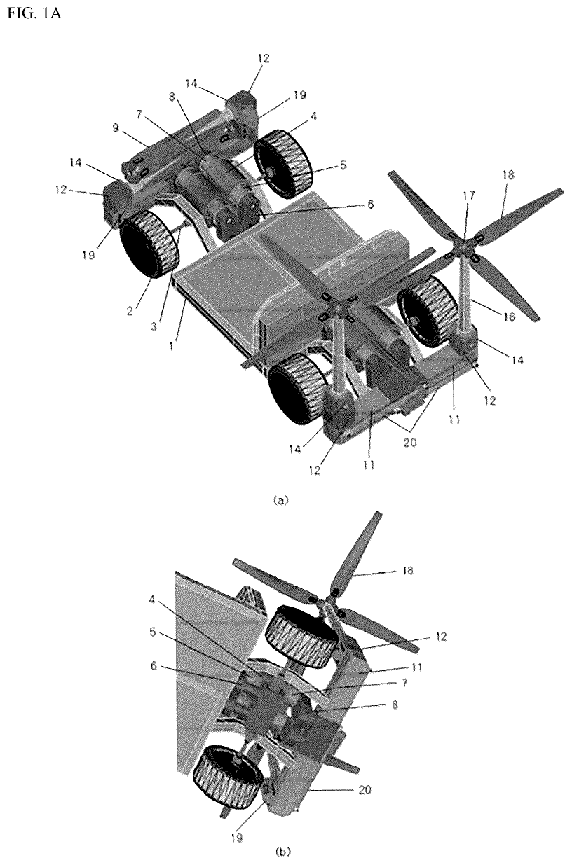

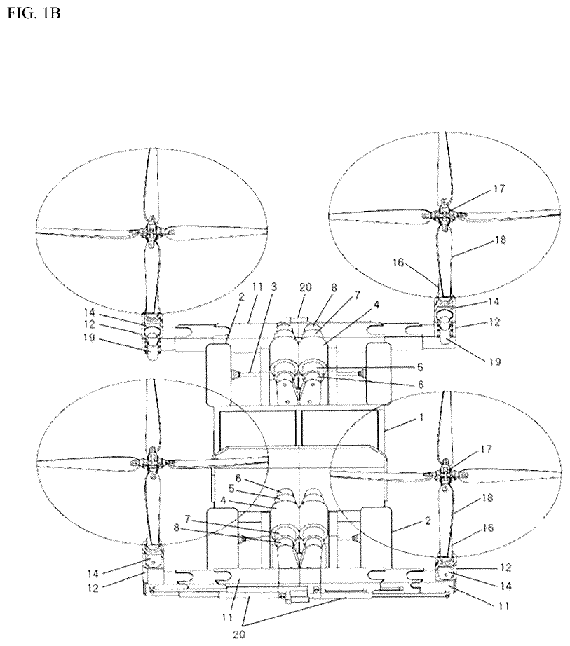

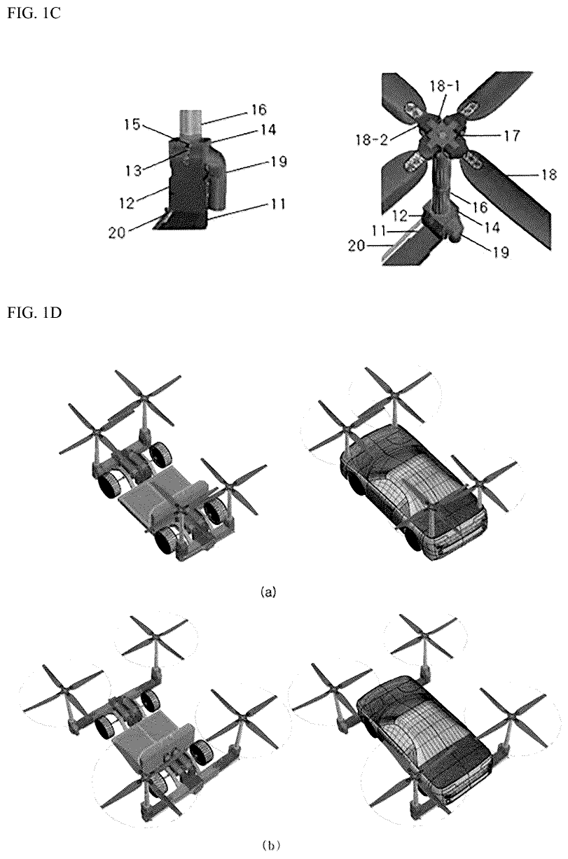

FIGS. 1A, 1B, 1C, and 1D are relevant drawings and will be described in more detail below.

FIG. 1A shows perspective views of an upper portion (a) and a lower portion (b) inside a chassis relating to a configuration of each power system and driving system of a flying car including a vertically standing rotor according to claim 1 of the present invention. The rotor is stored in a front portion of the chassis, and the rotor stands and blades thereof are deployed at a rear portion of the chassis.

FIG. 1B is a top view of the inside of the chassis relating to the configuration of each power system and driving system of the flying car including the vertically standing rotor according to claim 1 of the present invention. A state in which the rotor is expanded to the left and right and deployed is shown.

FIG. 1C shows perspective views of portions of the standing rotor of the flying car including the vertically standing rotor according to claim 1 of the present invention.

FIG. 1D shows perspective views of an interior and an exterior of the chassis in a state in which the rotor of the flying car including the vertically standing rotor according to claim 1 of the present invention is standing. (a) shows a state in which a flying horizontal driving transmission part is not expanded, and (b) shows a state in which the flying horizontal driving transmission part is expanded.

In a VTOL flying car of the invention relating to claim 1, each power system and driving system are provided in the chassis with the structure shown in FIG. 1A and so on based on a four-wheel electric car.

At upper portions of intermediate portions of central lines of wheel shafts 3 of a chassis 1, motors 4 are fixed and installed at a frame of the chassis so that a central axis of each motor 4 is perpendicular to one of the wheel shafts 3 and the motors 4 are adjacent, parallel, and symmetrical to each other while disposed at left and right sides with respect to a central line of the chassis 1. At both front and rear ends of the motors 4, a clutch 5 used for ground-traveling and a transmission 6 used for ground-traveling and having a predetermined deceleration ratio are sequentially in contact with and coupled to the motor 4 at an inner side of the chassis 1, and a clutch 7 used for flying and a transmission 8 used for flying and having a predetermined deceleration ratio are sequentially in contact with and coupled to the motor 4 at an outer side of the chassis 1. In this way, each power system which is a power train has a structure in which a transmission, a clutch, a common-use motor, another clutch, and another transmission are coaxially, linearly, and integrally formed in that order. Two power systems are arranged at front wheel sides, and two power systems are arranged at rear wheel sides such that a total of four identical power systems are configured inside the chassis 1.

The above structure is totally different from most structures in which motors and transmissions for driving an electric car are arranged parallel to wheel shafts beside the wheel shafts at a height identical to the height of the wheel shafts or are directly connected to the wheel shafts. Since the central axes of the applied motors 4 are perpendicular to the wheel shafts 3 of the front wheels or rear wheels while being arranged to be parallel at left and right sides with respect to the longitudinal central line of the chassis 1, the power systems which are configured by combining the motors 4 having a size of a certain level or more and which have a large length can be arranged in a limited chassis space, which has dimensions of a typical car, while allowing space to be secured for a controller (or inverter), which is a motor control device, a cooling device, and an air conditioner, allowing a steering space of the front wheels and a riding space relating to a wheel base such as passenger leg room to be secured, and not interfering with other parts related to the chassis 1. In this way, each power system can be used for both ground-traveling and flying, each of a ground-traveling driving system and a flying driving system, which will be described below, can be efficiently connected, a flying rotor 9 can be stored at a reasonable position in the space of the chassis 1, and ideal load distribution and symmetry of the parts can be secured without any problem.

Meanwhile, when the power systems each including the motor according to the present invention are arranged as described above, differently from a conventional electric car, there is a disadvantage in that the height of the center of gravity is increased. However, since a battery significantly heavier than the power systems is installed at a bottom portion of the chassis, the disadvantage in that the height of the center of gravity is increased is negligible. Meanwhile, although there is a disadvantage in that a freight loading space, that is, a trunk space, is consumed due to installation of the flying driving system, an unused space at the back of a passenger riding space may be utilized as the freight loading space in a two-seater coupé type flying car, and a riding space for three passengers at the back seat may be partially utilized as the freight loading space in a five-seater sedan type flying car.

In each power system configured as described above, by the clutches 5 and 7 coupled to both ends of the motors 4 being engaged or disengaged, the motors 4 may be selectively used for ground-traveling or flying. When the motors 4 are used for ground-traveling, in a state in which the flying clutch 7 coupled to an outer side of the vehicle is disconnected, the ground-traveling clutch 5 at an inner side of the vehicle is connected so that the motors 4 are used by being connected only to the ground-traveling driving system, and when the motors 4 are used for flying, the structure is the opposite to when the motors 4 are used for ground-traveling. In this way, it is possible to secure a structure in which four ground-traveling driving systems and four flying driving systems can each be independently operated.

For reference, a controller (or inverter) having a function of controlling driving of each motor 4 and engagement/disengagement of the clutches 5 and 7 includes four individual modules each installed in a space around one of the four power systems to individually control each power system and an integrated module having a function of integrally controlling the modules. Since the matters relating to such control are not closely related to the configurations of various mechanical devices which are the gist of the present invention, separate detailed description thereof will be omitted. Also, a battery configured to supply power is arranged at a bottom of a passenger compartment of the chassis 1 as in the form of a typical electric car.

The motors 4, the clutches 5 and 7, and the transmissions 6 and 8 are each coupled as in a typical case by driving parts such as driving shafts thereof being connected to each other by a spline coupling structure or the like and coupling parts thereof formed at both ends of a housing of each part being coupled using bolts, nuts, and the like to come in contact with each other. In this way, a single integrated power system in which a transmission, a clutch, the motor 4, another clutch, and another transmission are coupled in that order is formed, which facilitates separate repair of each part when needed, enables individual replacement or modification of each part, and particularly, enables each part to be individually changed, modified, replaced, coupled, or the like easily within a relatively short time in a development test process for finding the best combination of power systems, and facilitates product diversification or the like in a mass-production process. Also, unlike a typical structure in which, when a clutch at one side is disconnected during use, driving does not occur at all at that side, and a transmission is connected to a motor first, unnecessary power loss does not occur in a transmission.

Meanwhile, in another method, the motor, clutches, and transmissions of the integrated power system may be, instead of being coupled to come in contact with each other as in the present invention, configured to be integrally embedded in a motor housing. That is, a ground-traveling or flying clutch may be embedded in a space in which a housing at both front and rear ends of the motor is expanded, and then a ground-traveling or flying transmission which has a predetermined change gear ratio and is in the form of a planetary gear reducer or the like may be embedded in a single extending housing of the motor. In this way, a power system having a structure in which a transmission, a clutch, a motor, another clutch, and another transmission are integrally configured in that order in a single housing or a power system having a form in which a clutch, a motor, and another clutch are embedded in that order in a single housing, and an external transmission is coupled thereto may be applied. However, it may be difficult to modify or change each part in the integrated structure of a single housing, compared to the above-described individual coupling structure.

The motor applied to the VTOL flying car of the present invention greatly affects the efficient and reasonable configuration of the power systems as well as the performance of the flying car, and there are numerous types of motors according to function, performance, and the like including a power supply type motor, a magnetic flux type motor, and a rotary type motor. In consideration of the structures and usage conditions of the power systems, a typical inner runner type motor having a rotary central shaft and a radial flux motor may be applied as the motor in claim 1 of the present invention, but application to the present invention is not limited to specific types of motors.

For reference, in consideration of the total weight of the car, which is used as the flying car, rotor conditions, and the characteristic of VTOL flight requiring a high output, each motor 4 applied to the embodiments of the present invention has the maximum output ranging from 200 to 300 kw, a diameter around 280 mm, and a length around 330 mm, similar to typical developed, commercially available products. The structure of power systems to which the motor 4 having such dimensions is applied has been devised in consideration of all of various actual flying and ground-traveling conditions, current technology, and actual immediate practice, and embodiments thereof have been described, but the size of the motor, especially the length of the motor, may be significantly changed according to the type of motor that is used. For example, when an axial flux motor is applied, assuming that the maximum output and the number of rotations stay the same, the length of the motor may be significantly decreased while the diameter of the motor is slightly increased, and the weight of the motor may also be decreased in many cases. Due to the decrease in the length of the motor, the overall length of the power system in which a clutch and a transmission are coupled to both ends of the motor may also be significantly decreased. There are several different manners and structures according to manufacturers even for the axial flux motor, and axial flux motors that are suitable and applied to other forms of flying car structures, which are different from the flying car structure of claim 1, also have dimensions applied thereto based on actual development or already-developed products as in the embodiment relating to claim 1 and are illustrated in the drawings and used to devise the structure of power systems.

For the clutches 5 and 7, there are various structures and manners such as an electronic clutch, a hydraulic clutch, and a typical mechanical clutch, but any other device that can transmit and cut off power may belong to the concept of the present invention. However, in one embodiment of the present invention, a typical electronic clutch that does not require an additional device such as a hydraulic cylinder, a solenoid, or a pedal, can be operated by magnetizing a coil and moving an armature just by controlling an electrical input due to structures and characteristics of the present invention, and has a relatively small thickness is applied. The maximum transmittable torque may be changed according to ground-traveling or flying, and specifications may vary according thereto.

The transmissions 6 and 8 have a typical function of reducing a certain number of rotations of the motor with an appropriate change gear ratio to fit each number-of-rotations range suitable for driving ground-traveling wheels or flying rotors. Since the change gear ratio may also be different between a deceleration ratio for ground-traveling and a deceleration ratio for flying, a ground-traveling transmission and a flying transmission may be distinguished from each other and used differently at both ends of the same motor. Meanwhile, in the concept of the present invention, the transmissions also have an important function of reasonably and efficiently connecting the motors of each power system and each driving system in consideration of the structure and form of the ground-traveling driving system or the flying driving system, the structure of the vehicle, and the like, in addition to the typical function of reducing the number of rotations of the motor or increasing torque. Due to characteristics of the present invention, with respect to a driving motor, a ground-traveling transmission is positioned at an inner side of the chassis, and a flying transmission is positioned at an outer side of the chassis in order to be connected to a clutch coupled to the motor.

At a lower portion of the ground-traveling transmission 6 installed in each power system configured with the parts described above and installed at the inner side of the chassis 1, output units are formed toward the wheel shafts 3 which are at the outer side of the chassis 1, and ground-traveling driving systems each connected to one of four wheels 2, including two front wheels and two rear wheels, are configured in an L-shape or a reverse L-shape at left and right sides with respect to the longitudinal central line of the chassis 1. In order to allow driving at the output side to be finally transmitted to the wheel shafts 3, a driving shaft at the output side of the transmission 6 is connected to a gearbox in which a bevel gear engagement 10, which is in a horizontal direction toward the wheels and configured to change a direction of driving to the perpendicular direction, is embedded, and a wheel shaft 3 having a constant velocity (CV) joint for rotating the wheel 2 is installed at an output side toward the wheel shaft 3 of the bevel gear engagement 10 in the gearbox in order to be connected to the wheel 2 through a wheel hub. A ground-traveling drive train, that is, a ground-traveling driving system, having such a structure is installed at four sites.

Meanwhile, since various frames, a control arm, a strut (shock-absorbing bar), a sway bar, a steering mechanism, a hub, a knuckle, a brake device, and the like of the chassis 1 are the same as in typical configurations and are not the key gist of the present invention, illustration and description thereof will be omitted.

At a lower portion of the flying transmission 8 installed in each power system and installed at outer sides of front and rear portions of the chassis 1, output units are identically formed at the outer sides of the front and rear portions of the chassis 1, and a flying horizontal driving transmission part 11 configured so that driving transmission is horizontally performed in an L-shape or a reverse L-shape to left and right end portions of the front and rear portions of the chassis 1 and driving transmission is vertically performed at end portions thereof is installed. A driving shaft from an output side of the flying transmission 8 is connected to an input-side bevel gear of the bevel gear engagement 10 which is horizontal toward a side surface of the chassis 1 formed at the front, and a driving transmission shaft connected to an output-side bevel gear toward the side surface of the chassis 1, that is, in the perpendicular direction, is connected to the bevel gear engagement 10 which is vertical at end portions positioned at left and right corners of the front and rear portions of the chassis 1 to constitute the flying horizontal driving transmission part 11. In each combination of a driving shaft and a gear, housings thereof are of course configured and installed together and are positioned directly behind each bumper at the front and rear portions of the chassis 1, thus being supported by a frame or the like of the chassis 1 that is connected to the bumper.

Meanwhile, as in FIG. 1B and so on, the inner driving shaft and outer housing parts of the flying horizontal driving transmission part 11 are formed of a telescopic structure including several layers of spline-forming driving shafts and several layers of housings and are provided to be length-adjustable by an actuator 20 installed at an outer portion of the housing.

Next, at an upper portion of the housing of the vertical bevel gear engagement 10 coupled to the end of each flying horizontal driving transmission part 11, only a short driving transmission shaft is installed by direct connection at one of left and right sides of the front and rear portions of the chassis 1, and at the other of the left and right sides, in order to secure a storage space necessary for hinging of a vertically standing rotor 9 which will be described below, a driving transmission shaft having a height corresponding to a cross-sectional size of the vertically standing rotor 9 and a housing thereof are installed. Next, at an upper portion of each of the driving transmission shaft and the housing, a flying vertical driving transmission part 12 in which a bevel gear connected to a driving shaft from a lower portion is installed, the bevel gear has two left and right side gear type bevel gears engaged therewith in front and rear directions of the vehicle, and a housing having a form surrounding the two bevel gears is integrally configured and has a surface formed in an arc shape with an angle of 90° toward the inner side of the chassis 1 and a groove formed along the center of the surface to allow a driving shaft of a rotary bevel gear 13, which will be described below, to rotate is installed.

Here, the side gear type bevel gears are engaged with the lower bevel gear, rotate in opposite directions to rotate the rotary bevel gear again, have a larger diameter than the rotary bevel gear, and are installed at both left and right sides in the housing in order to safely and durably transmit high driving torque.

Next, in the housing of each flying vertical driving transmission part 12, a hinge rotation type driving transmission part 14 which is configured to surround left, right, and upper portions of the housing, has the rotary bevel gear 13 configured to be engaged with the side gear and rotate and a right-angled C-shaped hinge bracket, where a shaft of the rotary bevel gear 13 is installed, provided therein to be coupled by a hinge structure in a form surrounding left and right side surfaces of the housing of the flying vertical driving transmission part 12, and enables driving transmission through the rotary bevel gear 13 with 90° rotation horizontally toward the inner side of the chassis 1 and vertically upward is installed.

More specifically, at an upper portion of each hinge rotation type driving transmission part 14, a rotor driving shaft 15 coupled to the shaft of the rotary bevel gear 13 is installed together with a rotor housing 16 thereof, and at a rotor hub 17 which has a predetermined length and is installed at an upper end of the rotor driving shaft 15, four 90° rotating hinges are formed, and four blades 18 configured to be maintained and hinged horizontally and vertically due to a rotational centrifugal force, a self-weight, a horizontality-maintaining stopping protrusion 18-1, and a magnet 18-2 are each coupled to one of the hinges to constitute a single vertically standing rotor 9.

Here, a driven gear engaged with a rotor hinging servo 19 is coupled to brackets at left and right side surfaces of the hinge rotation type driving transmission part 14, and a final gear of the rotor hinging servo 19 to which a main body thereof is coupled is coupled to the flying vertical driving transmission part 12, which is a fixed part, so that, when the servo 19 is operated, the hinge rotation type driving transmission part 14 moves. In this way, the vertically standing rotor 9 is hinged horizontally and vertically.

That is, each vertically standing rotor 9 integrally formed with the hinge rotation type driving transmission part 14 is horizontally folded at a rotary hinge by the rotor hinging servo 19 or stands vertically. When horizontally folded, the rotors 9 each arranged at one of left and right sides of the front and rear portions are vertically laid over each other in the chassis 1, and when vertically standing, the rotor 9 laid on top stands first, and the rotor 9 at a lower portion stands next. When being horizontally folded again, the rotors 9 are folded in the opposite order from standing and are stored in the chassis.

By the above-described configuration of each part, a total of four flying driving systems of the vertically standing rotors 9 are provided.

The details of the embodiment of the present invention relating to claim 1 have been described above, and hereinafter, an operational process of a flying car according thereto will be described.

First, when the flying car is used for flying, chassis body panel dividing portions at an upper portion of each rotor 9 are opened, the rotor 9 laid on top among the rotors arranged at the left and right sides of the front and rear portions is caused to stand first by the servo 19 or the like, and when the flying clutch 7 is connected and then the motor 4 is operated in a state in which the ground-traveling clutch 5 is disconnected, driving of the motor 4 is transmitted to the rotor driving shaft 15 through the flying driving system, the rotor blades 18 rotate, causing all of the four blades 18 to horizontally deploy due to a centrifugal force and reach an idly rotating state, and then the rotor 9 that has been stored at a lower portion vertically stands and undergoes the same process as the top rotor 9 that has stood first, such that the rotor rotates, all of the four rotor blades 18 horizontally deploy and reach an idly rotating state, and the number of rotations of each motor 4 is increased to generate maximum thrust of the rotors for a vertical take-off, thus allowing the flying car to take off.

For reference, at the time of the take-off, when the rotors 9 at the left and right sides that have been vertically laid over each other in a horizontal state stand due to the rotor hinging servo 19, an end of the top rotor 9 that has stood first is higher than the height of an end of the standing lower rotor 9 due to a height difference of the flying vertical driving transmission parts 12 (no height difference in a diagonal direction between the front and rear portions). Accordingly, surfaces of blade disks that are horizontally formed have the same height difference and thus do not collide with each other, and the four blades 18 are provided for each rotor 9 and rotate, which is advantageous also in terms of generation of thrust. In a state in which the rotor blade 18 rotates, even when the horizontality-maintaining stopping protrusion 18-1, which is formed at an outer side surface of a blade 18-side hinge coupler toward the rotor hub 17, is caught at the rotor hub 17, and thus a rotational force increases, the blade 18 maintains horizontality, and when the rotation of the blade 18 is stopped, the blade 18 is vertically folded from a horizontally rotating state due to the self-weight and maintains the folded state due to the magnets 18-2 buried in and fixed to an inner side of the blade 18 side hinge coupler and an end of the rotor hub. At the time of the take-off, due to a centrifugal force acting on the rotor blade 18, the magnet at the blade 18 side hinge coupler is detached from the magnet at the hub, and the number of rotations is increased, thus reaching the horizontally rotating state.

During flying, basically in the same manner as a typical quadcopter drone, by simply controlling the number of rotations of the rotors 9 by separately controlling each motor 4, various flights such as vertical take-off and landing, moving forward, moving backward, moving leftward, moving rightward, moving upward, moving downward, and hovering are possible, autonomous flight control is relatively easy, and due to a simple structure that does not include a swash plate and a tail rotor, which are present in a typical helicopter, control problems or mechanical defects due to the swash plate or tail rotor do not occur.

After vertical landing, opposite to the take-off, power of the motor 4 at the lower rotor among the rotors 9 at the left and right sides is cut off first using the flying clutch 7 of the power system. In this way, the rotation of the blade 18 is stopped, the blades 18 of the rotor 9 that are vertically folded due to the self-weight are, using the servo 19 or the like, hinged to a space in the chassis in which the rotor 9 was originally stored. Then, the rotation of the higher rotor 9 is stopped, the blades 18 thereof are folded, and then the rotor 9 is stored to be laid over the lower rotor which has been stored first.

When the flying horizontal driving transmission part 11 being used is not length-adjustable, although rotary surfaces of the blades 18 partially overlap in a plan view, since there is a height difference between the rotors 9 at the left and right sides (no height difference in the diagonal direction), the blades 18 do not collide with each other, and in terms of generating thrust, although the rotary surfaces of the blades are positioned on portions of the chassis 1, due to the Coanda effect that may be generated on a side surface of the body of the chassis 1, the thrust is not significantly reduced. Also, there are advantages in that the rotary surfaces of the blades do not protrude much to the outside of the chassis 1 and thus occupy little space, and the operation is simple because the preparation for rotation of the rotors is completed just by causing the rotors 9 to stand.

Meanwhile, an operational process when length-adjustable portions of the horizontal driving transmission part 11 are used in the flying driving system will be separately described below. First, due to the actuator 20 installed at the housing of the horizontal driving transmission part 11, the horizontal driving transmission part 11 is horizontally extended and stopped due to left and right end portions thereof protruding to sides of the chassis 1, and then the chassis body panel dividing portions at the upper portion of each rotor in a horizontal state are opened, the rotors 9 at the left and right sides simultaneously stand vertically due to the servo 19 or the like, and as the rotors rotate, all of the blades 18 horizontally deploy due to a centrifugal force. Then, the open body panels are closed, and the preparation for vertical take-off is completed. At the time of landing, after the rotation of the rotors 9 is stopped, and the blades 18 in a horizontal state are vertically folded again due to the self-weight, the body panels are opened, the rotors 9 are horizontally folded, and the extended length-adjustable portions of the horizontal driving transmission part 11 are reduced to their original states. Then, the horizontal driving transmission part 11 is stored in its original position in the chassis together with the folded rotors 9, and the body panels are closed, thus reaching a state in which ground-traveling is possible. The length adjustment function may be used or not used according to circumstances, but it may be preferable to use the length adjustment function when the load capacity is high.

For ground-traveling, in each of the four power systems, the motor 4 is operated in a state in which the flying clutch 7 is disconnected and only the ground-traveling clutch 5 is connected. Then, through driving transmission of the ground-traveling driving system, the wheels 2 at the ends may be rolled to travel on the ground. Since each motor 4 may be separately controlled, that is, separate independent driving and speed control is possible for each of the four wheels, four-wheel independent driving in which separate driving of each wheel and simultaneous driving of all of the wheels are both possible according to circumstances is implemented.

Next, details for carrying out the present invention will be described in relation to claim 2.

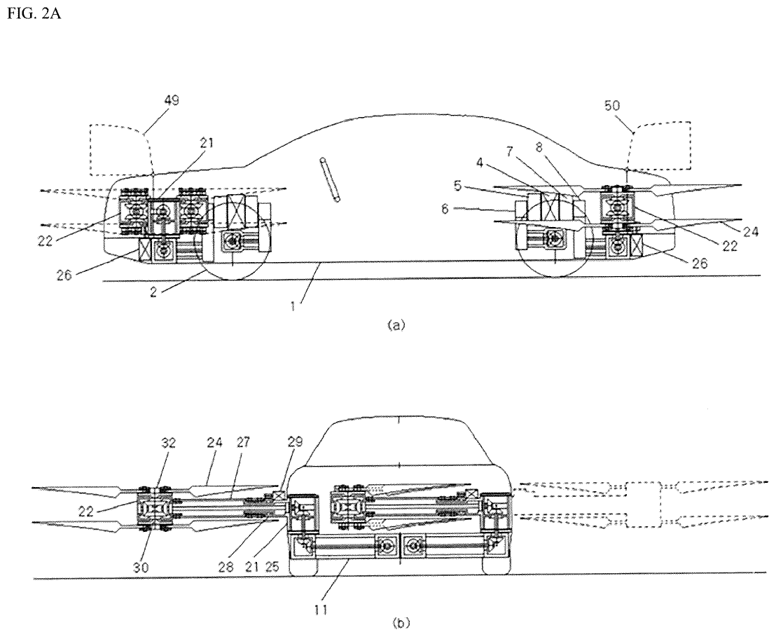

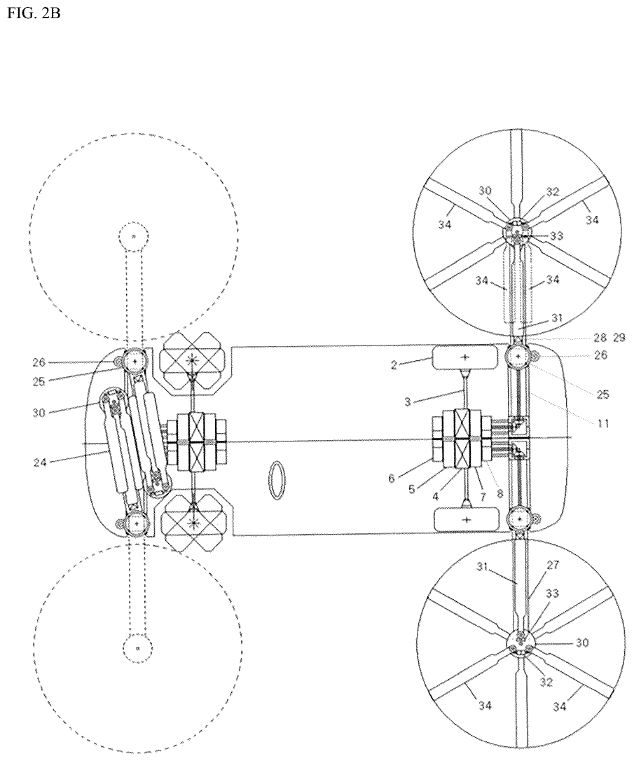

FIGS. 2A and 2B are relevant drawings and will be described in more detail below.

FIG. 2A shows a lateral view (a) and a rear view (b) of a configuration of each power system and driving system of a flying car including a horizontally rotating/deploying type coaxial contra-rotating double rotor according to claim 2 of the present invention. The front portion of the lateral view (a) shows a state in which the rotor is stored in a chassis, the rear portion of the lateral view (a) shows a state in which the rotor is deployed to the outside of the chassis, the left portion of the rear view (b) shows a state in which the rotor is deployed to the outside, and the right portion of the rear view (b) shows a state in which the rotor is stored inside the chassis.

FIG. 2B is a plan view relating to the configuration of each power system and driving system of the flying car including the horizontally rotating/deploying type coaxial contra-rotating double rotor according to claim 2 of the present invention. The front portion shows a state in which the rotor is stored inside the chassis, and the rear portion shows a state in which the rotor is deployed to the outside of the chassis.

In a VTOL flying car structure relating to claim 2, basic configurations and coupling orders of the power systems for both ground-traveling and flying are completely the same as in claim 1, the output of the motors 4 is also similar except that the length of the motors 4 is shorter, and the structure of the flying driving system is different from claim 1.

That is, while the motors 4 applied in the embodiment of claim 1 are a very common type of radial flux motors that are relatively long with a length around 330 mm, the motors 4 applied in claim 2 are axial flux motors that have a similar maximum output, a slightly larger diameter, and a significantly shorter length, which is around 200 mm, compared to typical motors. The power systems and ground-traveling driving systems are configured in the same coupling form as in claim 1, and only the flying driving systems are completely different from claim 1.

In addition to securing motor output and the like, the power systems for both ground-traveling and flying, which are the main features of the present invention, and a coupling structure thereof can be identically configured as when the radial flux motors are used, using the axial flux motors without any problem. Only the length of each power system is shortened, and there is likewise no problem in configuring and driving the ground-traveling driving systems having the same structure as in claim 1 using each power system.

That is, the ground-traveling driving system is formed in an L-shape or a reverse L-shape from each output unit formed toward the wheel shaft 3 of the ground-traveling transmission 6 of each power system and performs driving transmission to the wheels 2. Such a structure is the same as the driving transmission structure of claim 1.

In the flying driving system of claim 2, the structure is the same as in claim 1 up to an end portion of the horizontal driving transmission part 11 and is different from claim 1 after the end portion. After the end portion, a horizontally rotating/deploying type coaxial contra-rotating double rotor having a structure in which a rotor arm portion 23, which has a horizontal hinge type driving transmission part 21, a vertical coaxial contra-rotating double driving structure 22, and the like, and a blade portion 24 are sequentially connected is provided. In this way, the flying driving system of claim 2 is configured to have a completely different structure from the structure of the flying driving system of claim 1.

First, the horizontal hinge type driving transmission part 21 is provided to have a structure of a double cylinder type horizontally rotating hinge 25 including an inner housing which is coupled to a housing of the horizontal driving transmission part 11 at a lower portion and fixed and has a vertical-horizontal bevel gear engagement 10 configured to be coupled to a vertical driving shaft at the end portion of the horizontal driving transmission part 11 and change driving of the vertical driving shaft to horizontal again and a shaft of the vertical-horizontal bevel gear engagement 10 provided therein and an outer housing which is configured to surround the inner housing and rotate horizontally. For the horizontal rotation, a groove having a length slightly larger than a semicircle along which a horizontal driving shaft coupled to a vertical bevel gear, which is integrally formed with the outer housing while engaged with a horizontal bevel gear inside the inner housing, is able to move while horizontally rotating is formed in the middle of the inner housing, and a horizontal hinge rotating servo 26 is installed at an outer portion of the outer housing to rotate a gear formed at an outer surface of the outer housing. In this way, the outer housing integrally formed with the horizontal driving shaft can horizontally rotate while surrounding the inner housing.

The rotor arm portion 23 includes a horizontal rotor arm 27 configured by a driving transmission shaft having a slightly shorter length than a width of the chassis, which is coupled to the horizontal driving shaft of the horizontal hinge type driving transmission part 21 and the outer housing, and a housing of the driving transmission shaft. At a start point portion of the arm, a structure of a vertical hinge 28 for vertical rotation of the arm itself and a servo 29 of the structure are provided, and at an end portion of the arm, a vertical double bevel gear combination, a housing, and a hub plate 30 coupled to a vertical driving shaft are provided. In this way, the vertical coaxial contra-rotating double driving structure 22 that doubly vertically transmits driving is coupled.

When the outer housing of the horizontally rotating hinge 25 horizontally rotates due to the servo 26, the integrally formed rotor arm portion 23 horizontally rotates together, deploys at a side surface of the chassis 1, and then generates thrust for a vertical take-off and the like by operation of the motor 4 and the like, and when the servo 29 of the vertically rotating hinge 28 at the start point portion of the rotor arm portion 23 is operated, the rotor arm portion 23 rotates vertically, the rotor is tilted forward, and a state in which thrust for flying forward is generated is reached.

The above-described structures of the horizontal hinge 25 of the horizontal hinge type driving transmission part and the vertical hinge 28 of the rotor arm portion are only one embodiment of the present invention and not limited by the description, and a hinge structure having another structure may also be possible.

In relation to storage and external deployment of rotor arm portions 23, at the time of ground-traveling, as in FIG. 2B, the rotor arm portions 23 may be stored parallel to each other while tilted at an angle around 10° relative to the wheel shaft 3 at an upper portion of the horizontal driving transmission part 11 inside the front and rear portions of the chassis 1, at the time of flying, due to driving of the servo 26 at the horizontal hinge type driving transmission part 21, the rotor arm portions 23 may horizontally rotate to left and right outer spaces at the front and rear portions of the chassis, wherein an outer-side stored rotor is horizontally rotated around 170°, and an inner-side stored rotor is horizontally rotated around 190° such that both of the rotors deploy at a right angle relative to a side surface of the chassis, and at the end of flying, the rotor arm portions 23 return to their storage positions in the chassis through the opposite process, and when necessary, the angle of horizontal rotation/deployment of the rotor arm portions 23 may be reduced so that the rotor arm portions 23 deploy at an angle other than the right angle relative to the side surface of the chassis. Here, when an angle around 10° relative to the wheel shaft 3 is not secured when the rotor arm portions 23 are stored in the chassis, the rotor arm portions 23 may interfere and collide with steering of the front wheels or collide with the power system, and overhang at the front and rear of the chassis may increase and cause an increase in the overall length of the chassis or cause collision between the rotor arms and make it impossible to store the rotor arm portions 23. Thus, maintaining the storage angle is a very important factor.

The blade portion 24 includes three blades each having a length around 1 m that are coupled at 120° intervals to the hub plate 30 having a diameter around 30 cm that is coupled to each vertical driving shaft of the vertical coaxial contra-rotating double driving structure 22 at an end of the rotor arm portion 23. One of the three blades is a fixed blade 31, and the other two are movable blades 34 having a hinge structure. According to circumstances, worm gears formed on outer surfaces of hinge couplers of the movable blades 34 may be wirelessly rotated by a hinging servo 32 or the like to cause the movable blades 34 to horizontally rotate 120° for the fixed blade 31 to horizontally deploy or be folded again.

That is, at the time of flying, the rotor arm portions 23, which were folded and stored in the chassis 1 in the ground-traveling state, horizontally rotate and deploy at the right angle relative to the side surface of the chassis 1, and then the movable blades 34 at the left and right sides of the fixed blade 31 deploy 120° at a time in the opposite directions from each other such that the three vertical blades are spaced 120° from one another. Then, according to rotation of the motor 4 of the power system, the vertical blades contra-rotate relative to each other and generate thrust, thus allowing flying to occur. After landing, the motor 4 of the power system is controlled so that the fixed blade 31 is finally stopped on the rotor arm 27, and then the two left and right blades, which are the movable blades 34, rotate 120° at a time in the opposite directions from each other again so that the movable blades 34 are folded while portions thereof vertically overlap at the left and right sides of the fixed blade 31. Then, the rotor arm portions 23 rotate such that all of the rotors are stored in the chassis again, flying is finally completed, and preparation for using the flying car for ground-traveling is completed. Here, since each blade has a pitch angle given thereto, even when the left and right movable blades 34 partially overlap vertically at the front and rear of the fixed blade 31, the movable blades 34 do not collide with each other.

Meanwhile, all of the vertical blades are at the same positions vertically while folded and gathered or while deployed, and as the movable blades rotate, the blades rotate in the opposite directions from each other and vertically overlap every time the blades rotate 120°, but other than this, the blades rotate without individually overlapping. Thus, there is no problem in generating normal thrust, and an occurrence of eccentricity of the weight due to installation of the movable blade hinging servo 32 or the like at the hub plate 30 may be offset by installing an eccentricity-offsetting count weight 33 on the hub plate 30 at the opposite side of the servo 32. The blade hinging mechanism such as the movable blade hinging servo 32 is configured with a short-range wireless transmitter-receiver with the main body of the chassis 1, a servo motor, a battery, and the like and is installed to be fixed to the hub plate 30. However, on the other hand, the movable blades 34 may be folded due to a contractile force of a restoring spring installed at the hinge coupler and a fixing hook on the hub plate, and during rotation, may deploy due to a centrifugal force acting on the blades.

The overall process for flying will be described. First, after a front bonnet 49 and a rear trunk lid 50, which are rotor upper body panels at the front and rear portions of the chassis 1, are opened, of course, the rotor stored in the outer side portion of the chassis 1 horizontally rotates and deploys first, and then the rotor stored in the inner side portion deploys. Then, the open body panels 49 and 50 are closed, and blades of each deployed rotor deploy, and the flying clutch 7 of the power system for both ground-traveling and flying is connected thereto. Then, due to driving of the motor 4, the vertical double blades of each rotor contra-rotate relative to each other to perform a take-off for flying. After landing, in a process opposite to the take-off process, all of the rotors are stored, and then the ground-traveling clutch 5 of the power system for both ground-traveling and flying is connected to prepare for ground-traveling.

The chassis having the power system for both ground-traveling and flying, the ground-traveling driving system, and the flying driving system configured as described above has a significant advantage in terms of securing thrust because all of the four flying rotors are coaxial contra-rotating vertical double rotors. Thus, the chassis is suitable for a flying car having a chassis of a four-or-five-seater sedan type electric car whose total take-off weight is relatively heavy but may, of course, be applied to a flying car having a chassis of a two-seater coupé.

Next, details for carrying out the present invention will be described in relation to claim 3.

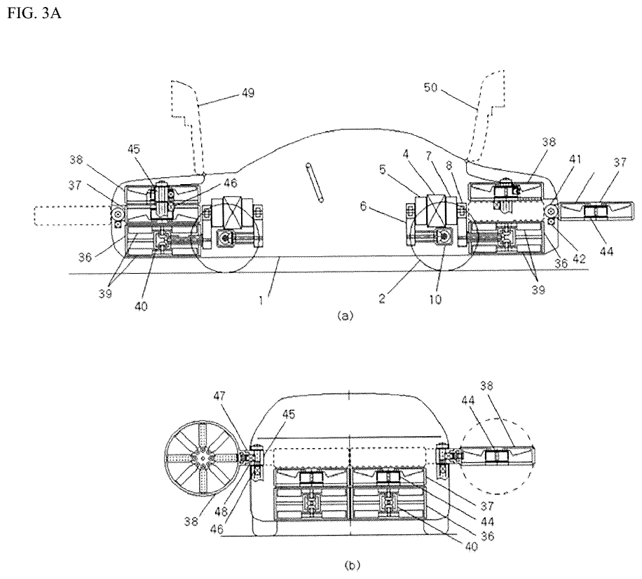

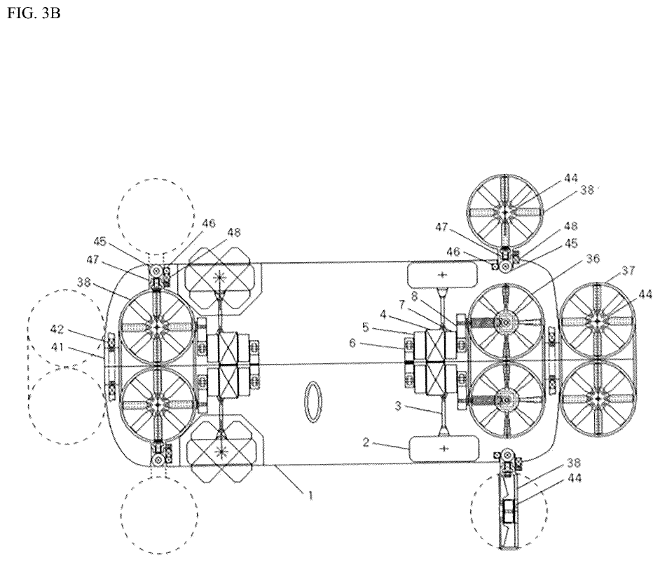

FIGS. 3A and 3B are relevant drawings and will be described in more detail below.

FIG. 3A shows a lateral view (a) and a rear view (b) of a configuration of each power system and driving system of a flying car including a vertical threefold ducted-fan type rotor according to claim 3 of the present invention. The front portion of the lateral view (a) shows a state in which all rotors are stored in a chassis, the rear portion of the lateral view (a) shows a state in which a middle rotor and a top rotor are deployed to the outside of the chassis, and the rear view (b) shows the state in which the middle rotor and the top rotor are deployed, wherein the left side of the rear view (b) shows a state in which the top rotor is horizontal, and the right side of the rear view (b) shows a state in which the top rotor is vertical.

FIG. 3B is a plan view relating to the configuration of each power system and driving system of the flying car including the vertical threefold ducted-fan type rotor according to claim 3 of the present invention. The front portion shows a state in which the rotors are stored in the chassis, and the rear portion shows a state in which the middle rotor and the top rotor are deployed to the outside of the chassis.

A VTOL flying car structure relating to claim 3 relates to a structure in which a vertical threefold ducted-fan type rotor is provided as a flying driving system in addition to power systems and ground-traveling driving systems identical to claim 1. Although the configuration and coupling order of the power systems are the same as in claim 1, axial flux motors with a short length are actually applied as the motors as in the structure of claim 2. Also, although the ground-traveling driving systems have the same structure as in claims 1 and 2, as the flying driving system, a vertical threefold ducted-fan type rotor which includes a bottom-layer flying driving part 36 provided as a ducted-fan type rotor having a structure of a coaxial contra-rotating vertical double fan 39 directly connected to the power system of claim 1 to receive driving transmitted therefrom, and a middle-layer flying driving part 37 and a top-layer flying driving part 38 disposed thereon which are provided as thin ducted-fan type rotors having a separate motor 44 and deploying in different forms to the outside of the chassis is provided.

First, the bottom-layer flying driving part 36 has a size that almost fills the space excluding a steering portion of wheels at a lower portion of each inner space between the wheel shaft 3 and front and rear bumpers of the chassis 1. One bottom-layer flying driving part 36 is provided at each of left and right sides with respect to the longitudinal central line of the chassis 1, and the two bottom-layer flying driving parts 36 constitute a pair and cause all of the ducted fans to be installed to be completely fixed to the chassis 1. Each bottom-layer flying driving part 36 is provided as a ducted fan having a structure including a vertical coaxial contra-rotating gearbox 40 configured to receive a driving force from the flying transmission 8 of the power system of claim 1 and a vertical double fan 39 having a driving transmission shaft, which is configured to be coupled to the vertical coaxial contra-rotating gearbox 40 to perform driving transmission, installed thereon. A set of two bottom-layer flying driving parts 36 is installed at each of the front and rear portions of the chassis 1, and a total of two sets are installed. Although the fan size of the bottom-layer flying driving part 36 is not that large, the bottom-layer flying driving part 36 has a double fan structure to convert as much power as possible to thrust because each ducted fan receives a great amount of power that is around 150 kw from the motor 4 of each of the four power systems of the chassis 1.

The middle-layer flying driving part 37 has the same size as the bottom-layer flying driving part 36 and is installed thereon. The middle-layer flying driving part 37 has one side fixed to front and rear edges of the chassis 1 by a structure of a vertically rotating hinge 41, vertically rotates 180° and horizontally deploys to outer spaces at the front and rear portions of the chassis by a servo 42 or the like, and is driven by the motor 44 provided therein. A set of two middle-layer flying driving parts 37, each of which is provided at one of the left and right sides, is provided as a thin ducted fan having an integrated structure. Similar to the bottom-layer flying driving parts 36, one set of the middle-layer flying driving parts 37 is installed at each of the front and rear portions of the chassis, and a total of two sets are installed. Each duct is driven by the motor 44 thereof whose output is around 60 kw and generates significantly less thrust than the bottom-layer flying driving parts 36.

The top-layer flying driving part 38 also has the same size as the middle-layer flying driving part 37 and is installed thereon. Each top-layer flying driving part 38 is separately installed at one of the left and right sides and has one side fixed to left and right edges of the chassis by a structure of a horizontally rotating hinge 45, deploys by horizontally rotating 180° to outer spaces at the left and right sides of the chassis 1 by a servo 46 or the like, and is driven by the motor 44 provided therein. A set of two top-layer flying driving parts 38, each of which is provided at one of the left and right sides to form a pair, is provided as a thin ducted fan. One set of top-layer flying driving parts 38 is installed at each of the front and rear portions of the chassis, and a total of two sets, that is, four top-layer flying driving parts 38, are installed. Similar to the middle-layer flying driving parts 37, each duct is driven by the motor 44 thereof whose output is around 60 kw and generates significantly less thrust than the bottom-layer flying driving parts. However, when necessary, the ducted fans may be rotated forward by operating a servo 48 of a vertically rotating hinge 47, which is provided at the rotor arm portion, and used for flying forward.

Structures including one large ducted fan or a plurality of small ducted fans are similar to the structure of claim 3, but all of such structures are simply driven using a motor in the ducted fan itself or a common-use engine and do not have driving structures that correspond one-to-one with wheels and can be used for both ground-traveling and flying by power systems for both ground-traveling and flying like the ducted fans of the bottom-layer flying driving parts of the present invention. Also, although ducted fans are installed to vertically overlap in a chassis or a plurality of small rotors are installed by simply being arranged in a row in some cases, the structure or manner of deployment to the outside of the chassis is different, a steering space of wheels is not taken into consideration, which makes it impossible to install a fan regardless of the size of the fan, and typical and reasonable installation of a ground-traveling driving system is also difficult in many cases.

That is, different from the conventional cases, the present invention includes ducted-fan type rotors having a very efficient, unique structure and manner in association with the power systems for both ground-traveling and flying, which are the features of the present invention. At each of the four power systems for both ground-traveling and flying provided with special conditions in the chassis, the flying ducted fan 36 is directly connected, and in relation to the arrangement thereof, the ducted-fan type rotors 37 and 38, which are not present in the conventional cases and include deployment to the front and rear portions of the chassis by a structure deploying to the front and rear of the chassis and deployment to the left and right sides of the chassis by a structure deploying to the left and right of the chassis, deploying by horizontal rotation, and also capable of vertically rotating to fly forward, are additionally installed in a complex, unique, and efficient way to generate maximum thrust. In this way, the present invention has features different from the conventional cases.

Opening of rotor upper body panels at the front and rear portions of the chassis 1 for external deployment of the middle-layer and top-layer rotors 37 and 38 is performed with the same structure and manner of electrically opening or closing the front bonnet 49 or the rear trunk lid 40 of a typical car, and the only difference is that portions of a fender and a bumper panel are integrally opened and closed. Since a mesh having a size slightly larger than the size of the bottom ducted fan inside the chassis is formed at an intermediate portion of an upper portion of a panel such as a bonnet or the like, even when, after each of the middle-layer and top-layer rotors 37 and 38 is deployed to the outside, the bonnet 49 and the trunk lid 50 are closed to perform flying, air may be suctioned into the bottom-layer flying driving part ducted fan 36, which is fixed to the inside of the chassis 1, without any problem.

As a type of a VTOL flying car that perfectly maintains the form of a typical car during ground-traveling, when ducted-fan type rotors are included, there may be a limitation in securing thrust. However, when multiple rotors are efficiently arranged as in the structure of the present invention, such a problem may be mitigated or eliminated.

The flying car structure relating to claim 3 is basically applied to a two-seater coupé type car whose total take-off weight is around 2,300 kg but, of course, may also be applied to a four-seater chassis when it is possible to secure a high motor output and thrust.

For flying, first, after the front bonnet 49 and the rear trunk lid 50, which are rotor upper body panels at the front and rear portions of the chassis 1, are opened, the top-layer flying driving parts 38 each horizontally rotate and deploy to the outer spaces at the left and right sides of the chassis by the hinge 45 and the servo 46. Then, the middle-layer flying driving parts 37 each vertically rotate and deploy to the outer spaces at the front and rear portions of the chassis by the hinge 41 and the servo 42. Then, after the rotor upper body panels 49 and 50 are closed, preparation for driving, that is, preparation for flying including a vertical take-off, is completed. Flying is performed by controlling the number of rotations of each rotor as in the case of a typical quadrotor drone, and in particular, the top-layer rotor 38 may have the form of a tilting rotor to fly forward by the provided vertical hinge 47 and servo 48 after a vertical take-off.

At the time of landing, a process is opposite to the take-off process. The middle-layer flying driving parts 37 are laid over the bottom-layer flying driving parts 36 inside the chassis and stored therein first. Then, the top-layer flying driving parts 38, which were deployed to the left and right of the chassis, are stored on the middle-layer flying driving parts 37. Then, the body panels 49 and 50 are closed, and preparation for ground-traveling as a car is completed. Since the power systems have the same structure as the power systems of claim 1, ground-traveling as a car becomes possible by the flying clutch 7 being disconnected and the ground-traveling clutch 5 being connected. Since the motor 4 of each of the four power systems for both ground-traveling and flying has a high output around 150 kw for flying, a total output for ground-traveling is around 600 kw, and thus, using the motors 4, it is possible to implement high ground-traveling performance similar to the performance of hypercars that exceeds the performance of supercars.

The flying car structure of claim 3 has great advantages such as being relatively simpler than a flying car structure in which typical rotors are used and consuming less space for take-off and landing but has disadvantages in that thrust generation efficiency is not that high, noise is relatively high, and the price of the car is high due to using a non-common-use, separate motor for an externally deploying ducted-fan and using an expensive special fan for generating high thrust.

Next, details for carrying out the present invention will be described in relation to claim 4.

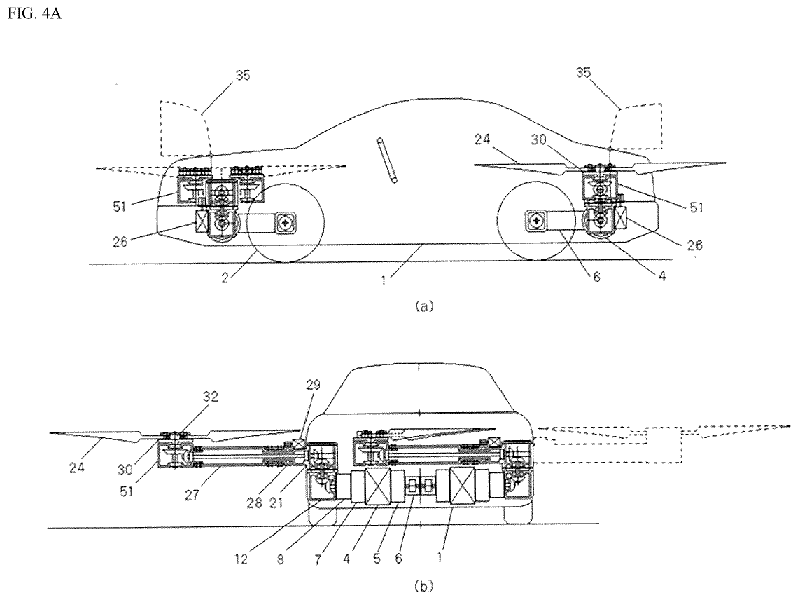

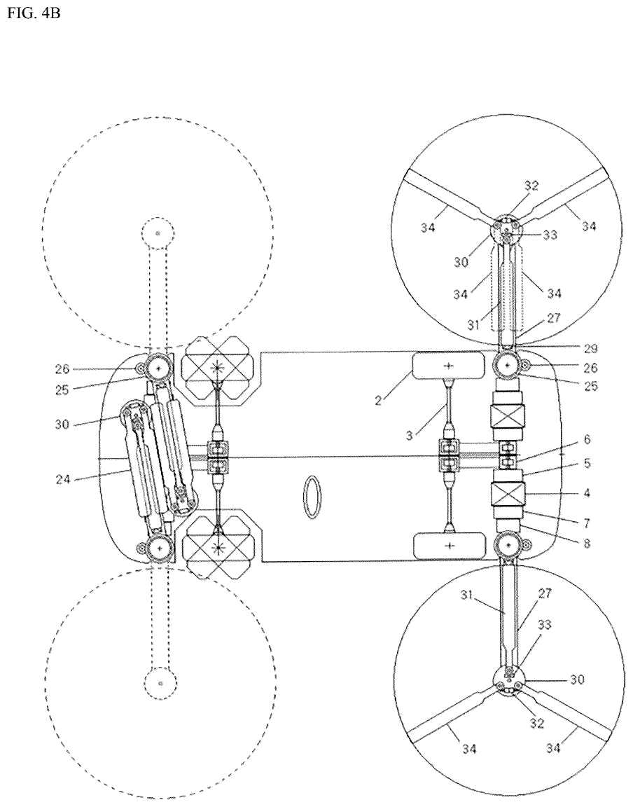

FIGS. 4A and 4B are relevant drawings and will be described in more detail below.

FIG. 4A shows a lateral view (a) and a rear view (b) of a configuration of each power system and driving system of a flying car including a horizontally rotating/deploying type single rotor according to claim 4 of the present invention. The front portion of the lateral view (a) shows a state in which the rotor is stored in a chassis, the rear portion of the lateral view (a) shows a state in which the rotor is deployed to the outside of the chassis, the left portion of the rear view (b) shows a state in which the rotor is deployed to the outside, and the right portion of the rear view (b) shows a state in which the rotor is stored inside the chassis.

FIG. 4B is a plan view relating to the configuration of each power system and driving system of the flying car including the horizontally rotating/deploying type single rotor according to claim 4 of the present invention. The front portion shows a state in which the rotor is stored inside the chassis, and the rear portion shows a state in which the rotor is deployed to the outside of the chassis.

Different from the power systems of claims 1, 2, and 3, in the power systems for both ground-traveling and flying of a VTOL flying car according to claim 4, motors 4 are installed to be adjacent and symmetrical to each other at left and right sides of a lower portion of each inner space between the wheel shaft 3 and the front and rear bumpers of the chassis 1 of a four-wheel electric car so that a central axis of each motor 4 is perpendicular to the longitudinal central line of the chassis, and at both front and rear ends of each motor 4, the clutch 5 and the transmission 6 used for ground-traveling are sequentially in contact with and coupled to the motor 4 at an inner side of the chassis 1, and the clutch 7 and the transmission 8 used for flying are sequentially in contact with and coupled to the motor 4 at an outer side of the chassis. In this way, each power system has a structure in which a transmission, a clutch, a motor, another clutch, and another transmission are coaxially, linearly, and integrally formed in that order. In the whole chassis 1, one power system for both ground-traveling and flying that can be separately and independently controlled is provided at each of left and right sides of the front and rear portions of the chassis 1, and a total of four power systems are provided. Axial flux motors with a relatively short length are basically applied as the motors 4 of each power system for both ground-traveling and flying, but common radial flux motors may also be applied when the output or the like of the motors is suitable and the length of the motors is decreased while the diameter of the motors is slightly increased. The ground-traveling transmission 6, which is a ground-traveling output unit of each power system, has a structure formed toward the wheel shaft 3 so that the output unit serves as a coupling portion of a CV joint of the wheel shaft 3 and is perpendicular to the central axis of the power system. Due to the form and connection structure of the flying driving system of claim 4, the flying transmission 8, which is a flying output unit, is in the form of a planetary gear reducer instead of a transmission having a common structure, and similar to the structures according to the other claims, each of the transmissions 6 and 8 also serves to transmit driving to each of the driving systems in addition to performing a gear shifting function.

In the ground-traveling driving system of claim 4, an inner CV joint spline shaft of the wheel shaft 3 is coupled to the output unit at an end of the ground-traveling transmission 6 of each power system. Accordingly, after the output unit, the ground-traveling driving system formed in the shape of a straight line and having the wheel shaft 3, the wheel 2, and the like configured therein is provided. Driving transmission inside the transmission from the clutch 5 side input portion of the ground-traveling transmission 6 to the CV joint coupling portion of the wheel shaft 3, which is the output portion, may be performed by a combination of gears but may also be performed using a chain, a belt, a pulley, or the like, which is more reasonable.

The flying driving system includes a horizontally rotating/deploying type rotor having a structure in which the vertical driving transmission part 12, the horizontal hinge type driving transmission part 21, the rotor arm portion 23, and the blade portion 24 are sequentially connected and which is provided from each output unit of the flying transmission 8 of each power system that is formed toward the side surface of the chassis 1.

The vertical driving transmission part 12 includes a structure which is connected to each output unit of the planetary gear reducer type flying transmission 8 of the power system for both ground-traveling and flying that is formed toward an outer side portion of the chassis 1 by a horizontal-vertical bevel gear engagement 10 to allow driving to be changed to vertical and a housing of the structure. The horizontal hinge type driving transmission part 21, the rotor arm portion 23, and the blade portion 24, which constitute the flying driving system after the vertical driving transmission part 12, are configured to have the same structures as in the flying driving system of claim 2 except that the rotor driving structure at the end of the rotor arm portion 23 is a single driving structure 51 which performs driving only vertically, either upward or downward, instead of a coaxial contra-rotating type vertical coaxial contra-rotating double driving structure 22, and thus only a single blade portion 24 is provided at an upper portion or a lower portion.

The embodiment and operational process of each part relating to claim 4 are the same as those described above in the embodiment of claim 2, and thus detailed description thereof will be omitted. In the flying car structure relating to claim 4, the four flying rotors have the single rotor structure 51 instead of the vertical double rotor structure 22, and thus there is a limitation in securing thrust. Accordingly, the flying car structure relating to claim 4 is basically suitable for a flying car having a chassis of a two-seater coupé type electric car whose total take-off weight is relatively very light as compared to a four-seater car. However, the rotor having the vertical coaxial contra-rotating double driving structure 22 as in claim 2 may, of course, be coupled to the power system for both ground-traveling and flying of claim 4 when the thickness of the rotor is reduced as much as possible, and since the form of a typical car can be secured while the height of the bonnet 49 of the chassis 1 is not abnormally increased, the flying car structure relating to claim 4 may also be applied to a four-seater flying car or the like in addition to a two-seater flying car.

Specific configurations and operations of each part relating to the embodiments of the present invention have been described above in relation to each claim. The estimated performance, industrial applicability, and the like according to the embodiments of the present invention will be described below based on a flying car including the power systems for both ground-traveling and flying, the ground-traveling driving systems, and the flying driving systems of coaxial contra-rotating double rotors according to claim 2, which relates to an embodiment of a four-seater sedan type flying car.

The net weight of a chassis of a four-seater car having the structure of the power systems, driving systems, and the like of claim 2 may be estimated to be about 1,900 kg. When about 500 kg is added thereto as a loading weight of a 130-kwh battery whose loading weight is currently around 4 kg per kwh (1 kg per 250 wh), about 2,400 kg is obtained. When 400 kg is added thereto as a riding capacity of four people including their luggage (91 kg/seat according to the Federal Aviation Administration (FAA) regulations), the total weight (maximum take-off weight (MTOW)) is expected to be 2,800 kg. A load weight of each of the four rotors is 700 kg at minimum.

When the flying car is used for flying, in consideration of vertical take-off and landing, the rotor structures of the present invention, and the like, it may be preferable for a ratio of total output to total weight (power/mass) to be around 0.4 kw/kg. Accordingly, when the sum of the magnitudes of power of the four power systems applied to the present invention is presumed to be 1,200 kw, and the magnitude of power of each power system is presumed to be 300 kw, the power/mass ratio is around 0.43 kw/kg, which is higher than the power/mass ratio, 0.36 kw/kg, of CityAirbus which has been developed for electric vertical take-off and landing (eVTOL) tests. In this way, it may be assumed that the operation of the flying car will be slightly quicker than City Airbus, and the output is secured at an appropriate level.

Also, rotors applicable to the structure of the present invention may each have a diameter around 2.1 m, a blade disk area per rotor may be about 6.92 m², and the total area may be 27.68 m². When a minimum estimate of thrust generated per unit area of a disk is considered to be 120 kg/m², which is in between values of thrust generated by V-22 Osprey and City Airbus which are similar rotor-type VTOL tilt-rotor aircrafts, the total thrust that may be generated may be about 3,320 kg at minimum. Accordingly, no problem is expected in VTOL or flying, and it may be assumed that blade areas and a thrust generating ability are secured at satisfactory levels. Also, in the invention according to each claim except for the vertically standing rotor of claim 1, since the structure causes the rotor to be extremely close to the ground, the Ground effect is also expected to occur during VTOL.

When the vertically rotating (rotor tilting) function of a horizontal rotor is performed to fly forward, the flying speed is estimated to be around 400 km/hr, which is relatively high among flying speeds of VTOL type urban air mobility (UAM) vehicles. The flying time is estimated to be short and around 25 minutes right now due to the current technology level of battery energy density but may be significantly increased in the future due to continuous progress in technology development relating to batteries such as all-solid-state batteries. For the meantime, the short flying time may be dealt with by replacing a battery pack or applying a hydrogen fuel cell or a separate engine for power generation.

During flying, basically in the same manner as a typical quadcopter drone, by simply controlling the number of rotations of the rotors by separately controlling each motor, various flights such as vertical take-off and landing, moving forward, moving backward, moving leftward, moving rightward, moving upward, moving downward, and hovering are possible like helicopters. Also, it is relatively easy to deal with pitching, rolling, yawing, and the like that occur due to unexpected gusts of wind, autonomous flight control will not be difficult, and since a swash plate, a tail rotor, and the like are not present unlike in helicopters, there are advantages in that the structure is simple, noise is slightly less, relatively less space is occupied, and flying costs are decreased.

For reference, in the structure of the present invention, since motors are embedded in a chassis, flying-related noise can be reduced to a certain extent, unlike the case where motors are mounted on external rotors and operated while exposed. Noise due to rotation of rotor blades is also expected to be reduced because the rotor blades are smaller than those in typical helicopters and are made of three to four blades. In the future, when various measures related to noise reduction such as soundproofing by sound absorption, sound insulation, and the like or active noise cancelling are continuously applied, noise will be significantly reduced, and it may be possible to implement low-noise UAM.

Meanwhile, in relation to a flight safety device, since the power systems and the driving systems are configured in a symmetrical manner at the front and rear portions of the chassis in the structure of the present invention, when necessary, an emergency ejection type parachute may be embedded at a reasonable position at an upper portion of the center of a passenger cabin of the chassis instead of being embedded in a portion where the blades rotate, which is an intermediate portion of the front and rear rotors that is also the center of gravity of the chassis. Accordingly, the flying car structure is also advantageous in terms of safe opening and operation of a parachute when there is a risk of losing thrust or thrust is lost during flying.

When the flying car is used for traveling on roads, since motors each having a high output around 300 kw are inevitably used in the four power systems in order to enable vertical take-off and landing of the chassis whose total weight is around 2,800 kg, the total output that may be used for ground-traveling is around 1,200 kw (about 1,600 HP), which is very high. Accordingly, during ground-traveling, a 0 to 100 kmph time is expected to be around 2 seconds, and the highest speed is expected to be 300 km/h or more, and thus ground-traveling performance is expected to be similar to the high ground-traveling performance of hypercars that exceeds the performance of supercars. The ground-traveling distance is also estimated to be at least 800 km or more due to mounting a battery having a capacity around 130 kwh.

Also, in the present invention, when the motor of each power system is used for ground-traveling, since one motor is provided for each wheel, and through separate control of each motor, separate independent driving, torque control, and the like of each of the four wheels are possible, active independent driving of four wheels, which is better than the conventional function of differential gears, is secured, and thus outstanding ground-traveling performance may be implemented on curved roads, snow-covered roads, rain-covered roads, sand-covered roads, or other rough roads. Although the arrangement of motors is different, the active independent driving of four wheels is the same as independent driving of four wheels that is applied to the Mercedes-Benz SLS AMG Electric Drive model in which one motor is arranged for each wheel. In addition, when necessary, the structure of the present invention may also include devices and control functions for the so-called “Tank Turn” which is a function of rotating in place or “Crab Mode” which is a function of horizontally moving. In the future, all electric cars are expected to be developed to have structures for independent driving and steering of four wheels, regardless of whether the motor output is high or low.

In addition, due to the characteristics of the present invention, there is no inconvenience due to transition between ground-traveling and flying, the present invention has a quadcopter structure in which automatic autonomous flying is easy, and the price of the flying car having the structure of the present invention will not be that high because the power systems in the structure can be used for both ground-traveling and flying. Accordingly, in addition to being generally used, the flying car may serve as a very efficient means of transportation in urban air transport services for UAM. In this way, the present invention has high industrial applicability.

Description of reference numerals.

| | |
|---|---|
| 1: chassis | 2: wheel |
| 3: wheel shaft | 4: motor |
| 5: ground-traveling clutch | 6: ground-traveling transmission |
| 7: flying clutch | 8: flying transmission |
| 9: vertically standing rotor | 10: bevel gear engagement |
| 11: flying horizontal driving transmission part | 12: flying vertical driving transmission part |
| 13: rotary bevel gear | 14: hinge rotation type driving transmission part |
| 15: rotor driving shaft | 16: rotor housing |
| 17: rotor hub | 18: rotor blade |
| 18-1: horizontality-maintaining stopping protrusion | 18-2: internally buried fixed magnet |
| 19: rotor hinging servo | 20: actuator |
| 21: horizontal hinge type driving transmission part | 22: vertical coaxial contra-rotating double driving structure |
| 23: rotor arm portion | 24: blade portion |
| 25: horizontally rotating hinge | 26: servo for horizontally rotating hinge |
| 27: rotor arm | 28: vertically rotating hinge |
| 29: servo for vertically rotating hinge | 30: hub plate |
| 31: fixed blade | 32: movable blade hinging wireless servo |
| 33: count weight | 34: movable blade |
| 35: upper body panel dividing portion | 36: bottom-layer flying driving part |
| 37: middle-layer flying driving part | 38: top-layer flying driving part |
| 39: vertical double fan | 40: vertical coaxial contra-rotating gearbox |
| 41: vertically rotating hinge for middle-layer flying driving part | 42: servo for vertically rotating hinge for middle-layer flying driving part |
| 43: thin ducted fan | 44: motor for ducted fan |
| 45: horizontally rotating hinge for top-layer flying driving part | 46: servo for horizontally rotating hinge for top-layer flying driving part |
| 47: vertically rotating hinge for top-layer flying driving part | 48: servo for vertically rotating hinge for top-layer flying driving part |
| 49: bonnet | 50: trunk lid |
| 51: upper vertical single driving structure | |

1. A vertical take-off and landing flying car comprising:
power systems for both ground-traveling and flying in which, at upper portions of intermediate portions of central lines of wheel shafts of front wheels and rear wheels of a four-wheel electric car, motors are installed to be adjacent, parallel, and symmetrical to each other at left and right sides with respect to a central line of a chassis so that a central axis of each motor is perpendicular to one of the wheel shafts, at both front and rear ends of each of the motors, a clutch and a transmission used for ground-traveling are sequentially in contact with and coupled to the motor at an inner side of the chassis, and a clutch and a transmission used for flying are sequentially in contact with and coupled to the motor at an outer side of the chassis such that a transmission, a clutch, a motor, another clutch, and another transmission are coaxially, linearly, and integrally formed in that order identically in each power system,
wherein a ground-traveling driving system is formed in an L-shape or a reverse L-shape from each output unit formed toward the wheel shaft at a lower portion of the ground-traveling transmission of each of the power systems and performs driving transmission to the wheel, and
from each output unit formed toward the outer side of the chassis at a lower portion of the flying transmission of each of the power systems, a vertically standing rotor is provided as a flying driving system, the flying driving system including horizontal driving transmission parts configured to perform horizontal driving transmission in an L-shape or a reverse L-shape to left and right side end portions of front and rear portions of the chassis and perform vertical driving transmission at a final end portion and having a telescopic structure in which an inner driving shaft of a horizontal driving transmission portion and a housing thereof are able to be stretched and contracted by an actuator, hinge rotation type vertical driving transmission parts each vertically coupled to an upper portion of an end portion of one of the horizontal driving transmission parts so that one of left and right sides of the hinge rotation type vertical driving transmission part is directly connected and the other side has a height that matches a cross-sectional size of a rotor part, and the rotor part configured by a driving shaft connected to the hinge rotation type vertical driving transmission part, a conical housing, a hub plate, and four hinging type blades being coupled.

2. The vertical take-off and landing flying car of claim 1, wherein, in the flying driving system, a horizontally rotating/deploying type coaxial contra-rotating double rotor is provided as a flying driving system after the horizontal driving transmission part, the flying driving system after the horizontal driving transmission part including:
a horizontal hinge type driving transmission part in which a structure coupled to a vertical driving shaft at the end portion of the horizontal driving transmission part to change driving of the vertical driving shaft to horizontal again is provided and which is provided to have a hinge structure housing that is able to horizontally rotate due to a servo:
a rotor arm portion which has an arm having a length slightly shorter than a width of the chassis and configured to have a driving transmission shaft coupled to a horizontal driving shaft of the horizontal hinge type driving transmission part and a housing of the driving transmission shaft, wherein, at a start point portion of the arm, a hinge structure for vertical rotation of the arm and a servo are provided, and at an end portion of the arm, a coaxial contra-rotating double driving transmission structure configured to doubly vertically transmit driving is coupled so that, during ground-traveling, the arm is stored at an angle around 10° relative to the wheel shaft inside the chassis, and during flying, the arm horizontally rotates and deploys to outer spaces at left and right sides of the front and rear portions of the chassis; and
a blade portion including three blades installed at 120° intervals on the hub plate coupled to each vertical driving shaft at the end portion of the rotor arm portion, wherein one of the three blades is a fixed blade, and the other two are movable blades installed as a hinge structure and configured to be hinged to left and right sides of the fixed blade by a wireless servo.

3. The vertical take-off and landing flying car of claim 1, wherein a vertical threefold ducted-fan type rotor is provided as the flying driving system, the flying driving system including:
a bottom-layer flying driving part formed of ducted fans having a coaxial contra-rotating vertical double fan structure configured to be driven by receiving a driving force from the flying transmission of the power system of claim 1, wherein each bottom-layer flying driving part is provided at one of left and right sides with respect to a longitudinal central line of the chassis at a lower portion of each inner space between the wheel shaft and front and rear bumpers of the chassis, and a pair of the two bottom-layer flying driving parts are installed to be fixed to the chassis;
a middle-layer flying driving part formed of thin ducted fans each of which is able to be deployed to outer spaces at the front and rear portions of the chassis by a servo and fixed and is driven by a motor provided therein, wherein each middle-layer flying driving part is provided at one of left and right sides on one of the bottom-layer flying driving parts, and a pair of the two middle-layer flying driving parts have one side installed to be fixed to edges of the front and rear portions of the chassis by a hinge structure; and
a top-layer flying driving part formed of thin ducted fans each of which is able to horizontally rotate and deploy to outer spaces at left and right sides of the chassis and tilt by a servo and is driven by a motor provided therein, wherein each top-layer flying driving part is provided at one of left and right sides on one of the middle-layer flying driving parts and has one side installed to be fixed to a short connecting arm of a vertically rotating hinge structure connected to a horizontally rotating hinge structure formed at left and right side edges of the front and rear portions of the chassis.

4. A vertical take-off and landing flying car comprising:
power systems for both ground-traveling and flying in which, at a lower portion of each inner space between a wheel shaft and front and rear bumpers of a chassis of a four-wheel electric car, motors are installed to be symmetrical to each other at left and right sides so that a central axis of each motor is perpendicular to a longitudinal central line of the chassis, at both front and rear ends of each of the motors, a clutch and a transmission used for ground-traveling are sequentially in contact with and coupled to the motor at an inner side of the chassis, and a clutch and a transmission used for flying are sequentially in contact with and coupled to the motor at an outer side of the chassis such that a transmission, a clutch, a motor, another clutch, and another transmission are coaxially, linearly, and integrally formed in that order identically in each power system,
wherein a ground-traveling driving system is formed in the shape of a straight line from each output unit formed at one wheel shaft portion of the chassis at the ground-traveling transmission of each of the power systems and performs driving transmission to the wheel, and
from each output unit formed toward one side surface of the chassis at the flying transmission of each of the power systems, a horizontally rotating/deploying type single rotor is provided as a flying driving system, the flying driving system including a vertical driving transmission part having a structure in which driving is changed to vertically upward, a horizontal hinge type driving transmission part in which a structure coupled to a vertical driving shaft of the vertical driving transmission part to change the driving to horizontal again is provided and which is provided to have a hinge structure housing that is able to horizontally rotate due to a servo, a rotor arm portion which has an arm having a length slightly shorter than a width of the chassis and configured to have a driving transmission shaft coupled to a horizontal driving shaft of the horizontal hinge type driving transmission part and a housing of the driving transmission shaft, wherein, at a start point portion of the arm, a hinge structure for vertical rotation of the arm and a servo are provided, and at an end portion of the arm, a structure in which driving is changed from horizontal to vertical is coupled so that, during ground-traveling, the arm is stored at an angle around 10° relative to the wheel shaft inside the chassis, and during flying, the arm horizontally rotates and deploys to outer spaces at left and right sides of front and rear portions of the chassis, and a blade portion including three blades installed at 120° intervals on a hub plate coupled to a vertical driving shaft at the end portion of the rotor arm portion, wherein one of the three blades is a fixed blade, and the other two are movable blades installed as a hinge structure and configured to be hinged to left and right sides of the fixed blade by a wireless servo.
